(19) United States
(12) Patent Application Publication
(10) Pub. No.: US 2014/0372462 A1
(43) Pub. Date: Dec. 18, 2014

(54) DATA MANAGEMENT SYSTEM AND METHOD

(71) Applicant: Michael Leahy Wise, Bellbowrie (AU)

(72) Inventor: Michael Leahy Wise, Bellbowrie (AU)

(73) Assignee: Trustee for the MMW Family Trust, Bellbowrie, Queensland (AU)

(21) Appl. No.: 14/373,956

(22) PCT Filed: Jan. 4, 2013
(86) PCT No.: PCT/AU2013/000004

§ 371 Date: Jul. 23, 2014

Related U.S. Application Data
(60) Provisional application No. 61/588,855, filed on Jan. 20, 2012.

(51) Int. Cl. G06F 17/30

(52) U.S. Cl. CPC G06F 17/30595
USPC 707/756

(57) ABSTRACT

A data management method enabling translation of content of a first data source into a second data source using an information platform is provided having a control layer, a definition layer and an execution layer.

### FIELD OF THE INVENTION

This invention relates to a data management system and method.

### BACKGROUND OF THE INVENTION

As Information Technology Standards mature, and application development processes become more efficient, application development accelerates and therefore applications proliferate. At the current time it is possible to develop applications in a fraction of the time that was the case 5 to 10 years ago, and this continues to accelerate. Further, mobile and tablet devices, and multiple major browser systems, for example Internet Explorer®, Firefox®, Chrome®, Safari®, mean that greater numbers of applications are available and need to be supported by organisations. As applications proliferate, then more organisations are attempting to move towards or implement a Service Oriented Architecture (SOA) strategy.

A first core concept of SOA is that it is a development of distributed computing and modular programming in which existing or new technologies are grouped into atomic systems. SOAs use software services to build applications. Services are relatively large, intrinsically unassociated units of functionality with externalised service descriptions. In an SOA environment, one or more services communicate with one another by passing data from one service to another, or coordinating an activity between one or more services. In this manner, atomic services can be orchestrated into higher-level services. The architecture defines protocols that describe how services can talk to each other, and independent services can be accessed without knowledge of the underlying platform implementation.

A second core concept of SOA is that of the Enterprise Services Bus (ESB) which is a technology type that is the mechanism through which different services communicate, and processing and scheduling is managed. An ESB is a conduit or middleware type technology, which ensures that messaging systems and services work in harmony and that processing is efficient while also distributed throughout the enterprise/organisation.

As applications proliferate, as individuals become more adept at utilising systems (and thereby create and use more data), and as communication between applications intensifies, the volume of data produced necessarily increases—this is currently at, or near, an exponential rate.

The growth of data itself, and the capture and analysis of that data, is referred to as ‘Big Data’. The capture, aggregation, management and analysis of data at scale is becoming more important in itself, as well as important for more organisations.

A further trend that is widely discussed and whose boundaries are not clearly defined is the advent of ‘the Cloud’. Cloud computing enables delivery of computing services where shared resources, software and information are provided to computing devices as a metered service over a network, such as the interne. The Cloud provides computation, software, data access and storage services that do not require end-user knowledge of the location and configuration of the system(s) that deliver the service(s).

The two main sub-trends are movement of applications and infrastructure into the cloud; and the rapidly increasing provision of services that are themselves based in the cloud (Software as a Service—SaaS).

The advent of web and browser-based systems has enabled the development of SaaS solutions, which when made available to a mass market can grow exponentially in size; these therefore lend themselves to provision from an infrastructure provider specialist, rather than from within a standard company, unless that company has significant experience in IT Infrastructure. More organisations are becoming used to consuming SaaS-based services from ‘the Cloud’.

Movement into the Cloud: as application communication has improved and data volumes have increased (see application proliferation and big data, above), and data transmission (telecom) technology's ability to carry high data volumes has increased, more organisations have begun to move single applications, services, or major operations into cloud-based infrastructures. The move to the cloud provides:
Improved costs due to economies of scale and specialism of providers.
Operational-based expenditure (OpEx rather than CapEx)/lower capital outlays leading to lower financial risks and liabilities.
Greater availability, performance and scalability due to the available infrastructure.
Improved Data Loss Prevention and Disaster Recovery from more robust infrastructure and management systems.

Migration of applications and services to the cloud is an already-major and still growing trend. Organisations are moving a proportion of their own applications into the cloud (some are moving all), and even when they are not, more services are being purchased and consumed which themselves are cloud based. In every instance the integration of these systems, and consequently their security and consistency of data, are of paramount JO concern.

Services are becoming available that seek to be the ‘cloud integration service’, such as Dell Boomi. To secure a combined selection of applications and services effectively, both on and off premise, it is necessary to provide both an integration platform and security.

In order to provide greater data consistency, data redundancy and data analysis across a hybrid deployment of applications (with or without further SaaS services) to the extent that would be required by a complex enterprise, it is necessary also to provide data management and data federation.

For the purchases of new applications; for application upgrades; and in particular for migration and then management of systems into the cloud, it is necessary to undertake systems migration, including data migration.

Data migration is one of the most labour-intensive and highest-risk parts of any systems migration or integration. Issues resulting from standard approaches to data migration, including those with most enterprise application upgrade or migration processes, include high cost; time; high risk of failure; lack of fallback options; and ensuing business and reputational risks from data issues.

Organisations that wish to move applications and services to the cloud have a combined challenge of the migration challenges, the integration and security challenges, and the consistent management of data across their hybrid environments.

The SOA concept also broadly encapsulates the complexity element of the issue, in that it is required in organisations that have complex application and service needs; it is therefore to some extent, by definition, implemented in large projects in complex organisations—this has at least been the case up until the present date.

This combination of factors—large projects, complex organisations, complex architectural concepts and processes, combined with definition problems as well as complex business, project and service elements, has led to a high proportion of SOA projects being viewed as expensive and either providing little value, or little easily-defined return on investment.

SOA is a collection of concepts and as such does not lend itself to encapsulation by a single product. However ESB technologies do exist and are a core underpinning for SOA. ESB products largely fall into two categories—free or open-source based such as Mule ESB, Apache Fuse and JBOSS ESB; and major vendor provided, such as WebSphere ESB or Oracle Fusion/Oracle Service Bus. Major vendor offerings are generally expensive, and attempt to lock the user/organisation into the vendor's products while still using some open standards (often provided by extra features or preferred integration paths, rather than extra cost). Open-source products have better price points, but usually require the same or even more specialist skills in order to be deployed and managed, and there is less in the way of professional/enterprise level support. Where an organisation (such as JBOSS) provides support services, there still remains the issue that the provision of the ESB does not approach the other key areas which the present invention seeks to address.

Integration projects are often extremely complex and have a poor record of success over time. Consequently, integration products are often associated with, and have been involved in, extensive and expensive projects. Simple integrations are often undertaken on an as-needs basis with a point-to-point development. This approach provides a quick resolution, but is inflexible, and as an organisation grows developments are usually inconsistent.

Organisations that encounter complexity often move to a hub-and-spoke model, where a single integration product processes all information between systems. This may require migration or redevelopment of all current integrations; once in place, this is more flexible than point-to-point integration. However for organisations that are larger; distributed geographically; complex; or have large data volume and processing needs; this system type will not be sufficient, and the organisation moves to a SOA-style process with distributed applications. At this point requirements include data federation as data locations and volumes become a challenge to the organisation.

The trends of application and data proliferation mean that scalable data processing becomes a greater priority for organisations. There is a growing requirement for transmission of transactions across multiple systems in all organisations, due to increased application volumes and integrations; the data volume from each application increases as applications themselves become more powerful; and further, there is then a greater requirement from the creation of the combinant cross-system information itself for ETL (Extract, Transform, Load) of that data and its storage. As per the ‘Big Data’ trend, users themselves are also creating much greater volumes of input data for systems.

With advances in technology, organisations are now looking to move their systems into processing incoming information throughout the organisation in real-time, at the same time as the data volume to be processed itself increases.

For larger organisations, Big Data leads to the requirement for Massively Parallel Processing systems, which can process the ever-increasing data volumes required by enterprise. Major vendors (such as IBM and Oracle) are pushing the boundaries of database technology to continue to facilitate these requirements. Further, there is significant collaboration between software vendors, database organisations, hardware manufacturers and chip makers to build specialised devices that can be more easily deployed, and achieve greater processing power for a defined hardware deployment; this optimisation is aimed at providing both greater processing power and a more defined/definable price point and deployment process for organisations. Purchase of these systems often ties the purchaser into an extended set of interlinked products in order to fully utilise the features available.

The extensive research input for these systems, as well as the size and market position of the organisations undertaking the research, means that there is a sizeable consequent cost to utilisation of these technologies. The technologies are rarely designed to have fully open standards, and are often themselves not easy to deploy and manage. Utilisation of specialised hardware-based systems means that the purchaser is locked in to further purchases of the same equipment for increases in processing capability.

For many organisations, access to more advanced technology and greater processing power is not possible due to expense. This is one factor that is key in organisations moving to cloud-based services, where it is perceived that processing is purchased as-used rather than with up-front expenditure on capital goods and implementation. Organisations are not currently able to utilise the elastic-compute power of the cloud across their internal systems without extensive cost.

It is necessary to have a development technology and framework to build robust, supportable and ideally reusable (see SOA) applications. Where there is an absence of a clear organisational standard, it is commonly seen that an application framework will be developed per team or area that has a need to do, so. This can occur even within organisations where an SOA, or at least a consistent architectural approach, is in place; without the appropriate management tools, management processes and oversight, it is extremely difficult to ensure consistency. In an environment where this process is manual, it is certain to fail to some extent as manual processes are extremely slow in larger organisations where many review and governance steps are required. Due to these issues, application development is often inconsistent and expensive.

Some major international organisations have a focus on broad enterprise application coverage, and have large Enterprise Application Technology Stacks that provide extensive functionality.

The application stacks owned and distributed by major vendors are made up of multiple applications, each in general targeted towards a specific area of use. The knowledge in these areas has been built up over an extended period of time, and thus many of these applications have a heritage from legacy technologies and legacy interfaces.

The combination of multiple products with a heritage of solving a specific technical issue, and the addition of purchasing competing technologies, means that the major vendors have an ongoing process of integration of multiple technologies to ensure smooth operation across the stack.

The first issue from this is that each vendor has a large volume of applications that must be purchased, deployed, configured, implemented, integrated and maintained by a purchasing organisation if that organisation requires a broad capability from that vendor. To implement the variety of applications an organisation must take on a significant and complex programme of work.

Such global vendors that lead the market in terms of integration, have applications and technologies for dealing with volume work for major organisations. However the systems are expensive, complex, and consequently slow to implement and difficult to maintain.

There are currently no technologies that seek to approach all of these issues—integration, ESB technology and data management through a consistent, single application and architectural approach.

### SUMMARY OF THE INVENTION

According to a first aspect of the invention, there is provided a data management method enabling translation of content of a first data source into a second data source using an information platform having a control layer, a definition layer and an execution layer, the method including:

connecting the information platform to the first data source by defining a workflow method in the definition layer to connect to the first data source;

establishing a data model in the definition layer to define requirements for the movement of data between the first data source and the second data source;

defining rules how the first and second data sources connect to one another including required transformations;

instantiating at least one node in the execution layer under the instruction of the workflow method;

executing the workflow method by at least one node to access data from the first data source;

establishing transformations to be carried out against the second data source using the defined rules;

executing the workflow method by at least one node to access data from the second data source; and

persisting data values in a persisted model based on the transformations.

According to a second aspect of the invention, there is provided a data management system enabling translation of content of a first data source into a second data source, the system including:

server means accessed through a communications network;

an information platform located on said server;

data storage means linked to said information platform;

wherein said information platform includes a control layer, a definition layer and an execution layer, each layer interacting with the other two layers;

wherein further the translation of the content between the data sources uses a workflow method executed in the execution layer and uses a data model to define requirements for the movement of data between the first data source and the second data source.

According to a third aspect of the invention, there is provided a computer-readable medium including computer-executable instructions that, when executed on a processor, in a data management method enabling translation of content of a first data source into a second data source using an information platform, said platform having a control layer, a definition layer and an execution layer, directs the processor to undertake any one or more of the steps of the first aspect.

The invention is described as an Information Platform, and comprises the capabilities of: an Integration Platform, ESB and SOA Management technology, Data Management, Master Data Management, Data Federation, Application Development Consistency (ASAP—Application Standardisation and Acceleration Platform), and Scalable Elastic Processing—through a consistent, single application and architectural approach. It seeks to resolve the following issues:

### Integration Complexity.

Configuration-Only Integration—The invention provides configuration-only integration, using adapters and a non-development user interface. System adapters are required, but once designed, no development is required to implement and manage integrations—this is provided by a small minority of currently available systems, for example Dell Boomi.

Data Source Translation—The invention, through an integration platform and workflow-control of data sources (Generation, Aggregation, Transformation, Serialisation) enables translation of any data source into any other type of supported data source (examples: XML, web service, Remote Procedure Call, email, spreadsheet. Word document . . . ). Refer to FIG. 6 for a more detailed explanation.

Flat File Integration—the above platform and Generation, Aggregation, Transformation, Serialisation process enables 2-way integration and updates to flat files whether structured or unstructured.

Through the combination of configuration-only integration management, simplified diverse-technology integration through translation, and file-based integration, the invention enables far greater homogeneity across an enterprise information and integration landscape than is currently possible.

### SOA Complexity.

The invention, through an integration platform and workflow-control of data sources (Generation, Aggregation, Transformation, Serialisation) enables translation of any data source into any other type of supported data source, (examples: XML, web service, Remote Procedure Call, email, spreadsheet, Word document . . . ). In combination with configuration-only integration management and file-based integration, this enables far greater homogeneity across an enterprise information and integration landscape than is currently possible without multiple applications and technologies.

The invention supports interaction with multiple messaging systems and ESBs, facilitating tracking and visualisation of these across the enterprise. This enables a complete and consistent picture of the core component technologies of enterprise SOA within disparate environments. Refer to FIG. 10 for a more detailed explanation.

The invention provides an Application Standardisation and Acceleration Platform; a system of services management and interaction, with a development framework, that enables faster application development through re-use of core information and core systems that themselves can be defined by the enterprise. This both accelerates development and, as the applications are developed against the platform, ensures consistent integration of the applications into the integration and processing landscape; and therefore the SOA.

Across all of these items the invention then enables graphical visualisation of every data source (systems, files), every connection point, every endpoint, every data-workflow of to information, every processing point, and every transaction throughout the enterprise. This capability radically reduces the complexity of designing, implementing, managing, and understanding SOA. Refer to FIG. 10 for a more detailed explanation.

### SOA Processing Power and Speed.

The invention seeks to avoid hardware-dependent optimisation by enabling asynchronous processing of messaging and transactions across a scalable volume of nodes that interact with a data repository(ies), each node itself multi-threaded and capable of processing high data volumes. When configured to do so the invention can also instantiate more nodes onto available hardware on demand in order to increase processing power. Refer to FIG. 8 for a more detailed explanation.

While this approach by itself may not reach current Massively Parallel. Processing record benchmark speeds, it enables enterprises to process sizeable volumes of information on any hardware, in any suitable environment, in any required location. Multi-node processing, and the ability to rapidly scale processing node volumes up or down, combine with the capability to prioritise transactions and data sources to enable the enterprise to manage heavy data loads, unpredictable data patterns, and processing spikes.

### SOA Implementation Risks

The invention enables a significant reduction in SOA complexity. This reduction in the complexity of SOA significantly reduces the risks in building, implementing, and managing an SOA strategy. The integration platform, the ESB and SOA interaction, and the ASAP platform, combined with a single view (or point of access, or repository) of all organisational data sources, radically reduces the complexity of designing, implementing, managing, and understanding SOA.

### Systems and Data Migration Risks

The invention utilises the combination of an integration platform, data management and transaction storage, Master Data Management, business rules and Data DNA, to resolve key issues in the standard approach to systems- and data-migration. Refer to FIGS. 6 and 7 for a more detailed explanation.

The invention actually enables, in many circumstances, an organisation not to migrate their users at all; the integration platform, translation capability and Master Data Management with business rules in place for processing, mean that users can continue to use their current system or file(s), in the same manner as before, and yet be integrated in real-time into the core business data of the organisation.

Where an organisation must migrate users to a system, then the following issues are resolved:

Integration—integration is made as simple as possible (Integration complexity is covered above).

Data migration—rather than using a specific import process, data is sent through a data workflow by the integration platform. Instead of using a single import process, the data workflow is referenced (processed) through the data model(s) held by the Master Data Management system. Thus a coherent dataset is produced in reference to the organisational data models while the system is still running, rather than data being ‘sliced off’ (ie taken at a point in time) or exported. Utilising hierarchical (or prioritised) business rules working through the data model to a single field level (i.e. Every data item is processed against rules), the data is updated to the target system (or systems) and can either populate the system(s) from scratch (akin to a standard (advanced) migration), or update the target system even if there is a dataset or sets in the system already. Refer to FIGS. 6 and 7 for a more detailed explanation.

Thus the data migration process is simplified in terms of import, and the old and new systems can both run simultaneously working off the same dataset (which has been combined through the MDM into the data repository and persisted data model). As a byproduct, where there is more than one overlapping dataset to be migrated, the data quality is significantly increased by combining the data.

Systems Cutover—with the combination of the integration platform, and the data migration underpinned by Master Data Management, with consistent data management (transaction-level storage across a data repository), it is not necessary to switch off the ‘outgoing’ system(s), nor make them read-only; thus users do not have to use two systems at once, double handle information, or learn a new system under a pressurized timescale. Users can use any system involved in the migration effectively and update the core organisational data, while the training program and personnel cutovers (movement of user accounts from one system to the other) can occur at the speed required by the organisation.

Failure/Rollback process—for a standard systems migration, once data is combined into the new system, it is not possible to repeal (or more accurately undo) the implementation of the data. Due to the transactional nature of the invention, ‘Data DNA’ (all data items, to the field level, are identified with a Single Point Of Truth, and given a unique GUM; also all transactions affecting each data item are tracked, so there is total data history) means that it is possible to repeal data changes, and also to change data models and business rules, should there have been mistakes made. With data in flight (i.e. being updated from one or more sources), rather than repeal the system to a prior state and lose work, the invention repeals information through the data model and business rules in order to ensure data integrity is maintained.

### Hybrid On- and Off-Premise Environments.

There are multiple challenges associated with moving to and then managing and supporting a hybrid on- and off-premise environment—systems integration, data processing, data redundancy (disaster recovery), application redundancy, application and data security, and migration challenges. The invention seeks to resolve all of these:

Integration platform—the integration platform enables the applications in different environments to communicate. Refer to FIG. 6 for a more detailed explanation.

ESB processing and SOA visibility—the invention's ESB and SOA components enable consistent data processing at scale through a distributed multi-environment organisation. The invention also enables consistency in review and management of systems in both on- and off-premise environments; and the ability to develop new capabilities easily and integrate them to the application stack, either in internal environments, external environments, or by adding third party services. Refer to FIG. 10 for a more detailed explanation.

Data and application redundancy—applications in different locations that are connected create a risk of system failure when communication links are severed, or even throttled/inhibited. The invention enables an organisation, through its distributed architecture, ESB and multiple data repositories, to achieve data redundancy in any local environment where a data repository is situated. As communication links are severed, any systems communicating with the local data repository will continue to act as if the unavailable systems are still available, with data present as at the time of communication loss. When communication links are re-established, processing nodes will process all outstanding transactions through business rules until all systems have cleared message/transaction queues. In the event of a catastrophic loss of an environment, the data repository can be re-instantiated in any environment from the other surviving data repositories.

Migration challenges—the invention thoroughly mitigates all systems and data migration challenges—these are covered above as ‘systems and data migration risks’.

Application and data security—the invention provides role based access control, transaction certification and encryption of data and data repositories. The invention also works closely with any number of identity or credentialing systems to ensure an organisation's identity security is maintained throughout integrated data sources.

The combination of these capabilities enables an organisation to manage systems integration, SOA and data management across both the internal environment and any number of private cloud services or public SaaS services.

### Technology Complexity and Cost-to-Implement & Maintain

The invention is designed to be deployed as a single multi-tier application, and consequently is significantly less complex to deploy and manage than technology stacks that offer comparable functionality. The cost to implement for an organisation is also therefore significantly lower.

The cost to iterate development of the invention itself is significantly lower than maintaining a complex enterprise stack, meaning that the cost of maintaining and upgrading the solution will also be commensurately lower.

### Legacy Technology Issues & Access to New and Emergent Technology Standards

The invention makes use of the latest development technologies and open standards, and is not designed to be restrictive in any way. Any organisation can develop adapter components for the system rapidly and easily, and with the single-application architecture and corresponding lower research and development cost to iterate improvements, the invention will be able to keep up with the latest standards.

### Scalable Data Processing

The invention seeks to avoid hardware-dependent optimisation by enabling asynchronous processing of messaging and transactions across a scalable volume of nodes that interact with a data repository(ies), each node itself multi-threaded and capable of processing high data volumes. When configured to do so the invention can also instantiate more nodes onto available hardware on demand in order to increase processing power. This ‘Swarm’ based asynchronous processing approach achieves high volumes of data processing for an organisation.

The invention has no restriction to hardware type, and supports virtualisation for massive and rapid instantiation capability. An organisation can utilise both their on-premise and off-premise nodes for processing, in order to take advantage of cloud-based elastic compute power.

Multi-node processing, and the ability to rapidly scale processing node volumes up or down, combine with the capability to prioritise transactions and data sources to enable the enterprise to manage heavy data loads, unpredictable data patterns, and processing spikes.

### Consistent Application Development

The invention contains an Application Standardisation and Acceleration Platform (ASAP), that facilitates consistent application development. Given that the system intends to be the focus of all organisational data and supports core services including identity, rather than separately repetitively rewriting these items, reuse is made of platform metadata to describe applications. The concept closely follows OSGI (Open Service Gateway Initiative) with elements of CASE (Computer Aided Software to Engineering), specifically its modular approach with bundled services. The development language itself is not dictated but the platform enables the leveraging of open standards to develop ‘standardised’ applications at greater speed. Where it has been determined that an application should be developed, the development team is therefore able to deliver greater value to the organisation. Refer to FIG. 9 for a more detailed explanation.

Where it has been determined that an application is not needed, or that an application may previously have been needed (but now is not, due to the invention), the invention is able to translate data sources via the integration platform and workflow-control into a format and service that is useable by other applications. Consequently, in many instances it will not be necessary to undertake application development, and yet still provide the outcome of consistent application development (i.e. Available data and functionality as if the application had been developed).

### Project Risks, Change Management, Training Costs—for all Areas

The invention seeks to combine all the capabilities discussed—Integration Platform, ESB and SOA Management technology, Data Management, Master Data Management, Data Federation, Application Development Consistency (ASAP—Application Standardisation and Acceleration Platform), and Scalable Elastic Processing—into one application. This significantly reduces the complexity of project work in these areas, with associated change management and training costs.

The capabilities of running systems synchronously through utilisation of the integration platform in combination with Master Data Management and consistent data management (transaction level storage across a data repository) mean that business disruption is minimised, significantly reducing the efforts involved in, and time pressure on, change management and training costs for systems implementations, upgrades and migrations.

In summary, the invention enables any enterprise to resolve data and application proliferation, by enabling them to master integrations, manage their Service Oriented Architecture, control organisational data, and coordinate application development and deployment, all from one robust, flexible, scalable and open application platform.

### BRIEF DESCRIPTION OF THE DRAWINGS

Preferred embodiments of the invention will hereinafter be described, by way of example only, with reference to the drawings in which:

FIG. 1 is a block diagram of a data management system accessed internally or over a communications system, such as the internet, and existing in an on-premise environment;

FIG. 2 is a block diagram of a data management system formed partly in an on-premise environment accessed internally and partly in an externally hosted environment accessed over a communications system, such as the internet;

FIG. 3 is a block diagram of the logical structure of an information platform contained in the data management system and showing the control, definition and execution layers and how each layer interacts with a content layer;

FIG. 4 is a block diagram showing the components or modules in each of the control, definition and execution layers of the information platform of FIG. 3;

FIG. 5 is a block diagram of a high-level information state of an organisation that has resolved data and application proliferation as well as combining on-premise and Cloud-based services;

FIG. 6 is a block diagram showing the process of integration, workflow and migration/translation of content between two data sources using the information platform;

FIG. 7 is a block diagram similar to FIG. 6 showing the process of integration, workflow and migration/translation of content between multiple data sources using the information platform;

FIG. 8 is a block diagram showing the scalability of the system using multiple nodes in the execution layer during increased processing loads;

FIG. 9 is a block diagram showing an application development process using the information platform;

FIG. 10 is a block diagram depicting the application architecture, integration capability, processing capability, and the application development process of the system, and then depicts how these relate to the ability to manage and visualise Service Oriented Architecture;

FIG. 11 is a block diagram of the information platform deployed to an organisation's requirements according to a first embodiment;

FIG. 12 is a block diagram of the information platform deployed to an organisation's requirements according to a second embodiment using a main site and two mobile sites; and

FIG. 13 is a block diagram of the information platform deployed to a group's requirements according to an embodiment.

### DETAILED DESCRIPTION OF THE PREFERRED EMBODIMENT

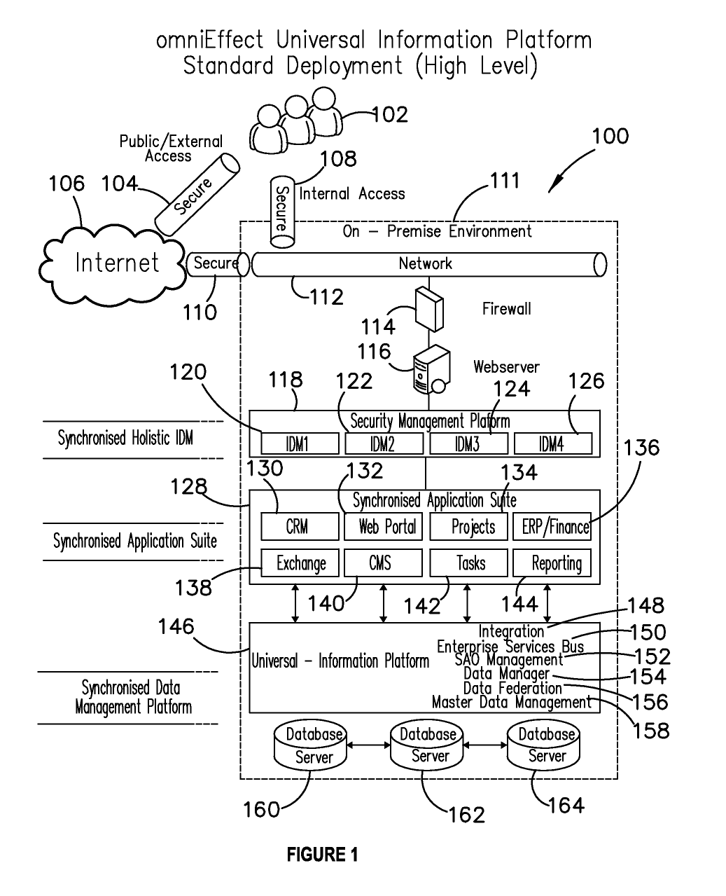

Referring to FIG. 1 there is depicted a block diagram of a system 100 of the logical positioning of an embodiment of the invention within an organisation's information systems.

The system 100 includes an on-premise environment 111 connected through a secure link 110 to the internet 106. Consumers, who can be internal staff or individuals external to the organisation, can access the information stored in the environment 111 internally through the organisation's network through link 108 or externally through link 104, the internet 106 and secure link 110. Internet services are fed with information controlled and managed from the organisation's network 112 over the link 110.

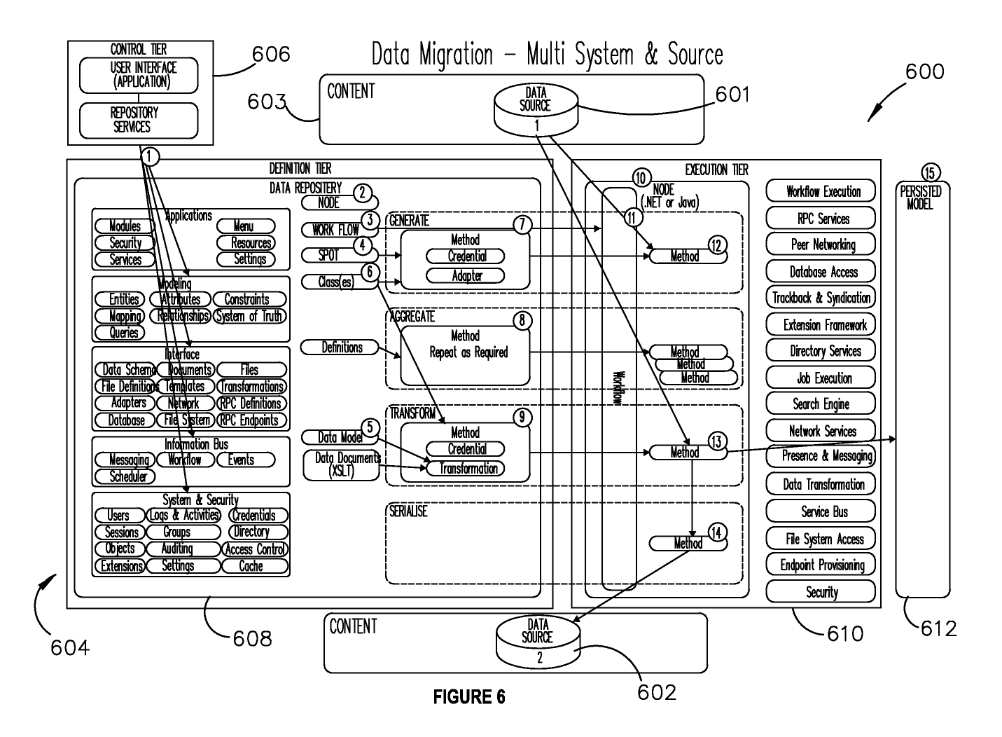

Security for the information located in the environment 111 is provided by a firewall network security system connected to the organisation's network 112. The firewall system 114 is connected to web server 116 which in turn is linked to a security management platform 118. The security management platform 118 includes a number of identity management systems (IDM), in this instance four IDMs 120, 122, 124 and 126 are identified in the platform 118. These are IDM's are synchronised providing a holistic IDM capability. The security of the information within the network is provided by authentication and identity management from the organisation's identity systems. Linked to the security management platform 118 is a synchronized application suite 128 which contains a number of modules being CRM 130, Web Portal 132, Projects 134, ERP/Finance 136, Exchange 138, CMS 140, Tasks 142 and Reporting module 144. The application suite 128 in turn is linked to an information platform 146 which includes an integration platform 148, an enterprise services bus (ESB) platform 150, an SOA management platform 152, a data management platform 154, a data federation platform 156 and master data management platform 158. Information is created in, updated in and passed through the organisation's application suite 128. The suite 128 is synchronized in terms of both data (data matching quality) and processing speed (time) by the information platform 146. Further detail on the information flow is provided with reference to FIGS. 6, 7 and 8.

The information platform 146 is integrated to all core applications and content within the organisation. Data management platform 154 ensures that data transactions are kept consistent to business rules and data models. The ESB platform 150 ensures that all messaging is processed in real time. Data is stored appropriately in multiple locations for redundancy, in this case database servers 160, 162 and 164. The information platform 146 and the data base servers 160 to 164 represent a synchronized data management platform for the organisation.

An example of business rules and data models would relate to a Person. A person may exist in multiple systems that have different records of the person's mobile phone number over time. A data model would describe how to manage the details of that person (name, address, email, phone, mobile phone) over the multiple systems. The business rules would explain, when a change occurs to a single piece of data in one system, for instance the mobile phone number, what should happen to that update. Rule options could include, for example, allow the update, reject the update or hold the update and notify an individual user for confirmation.

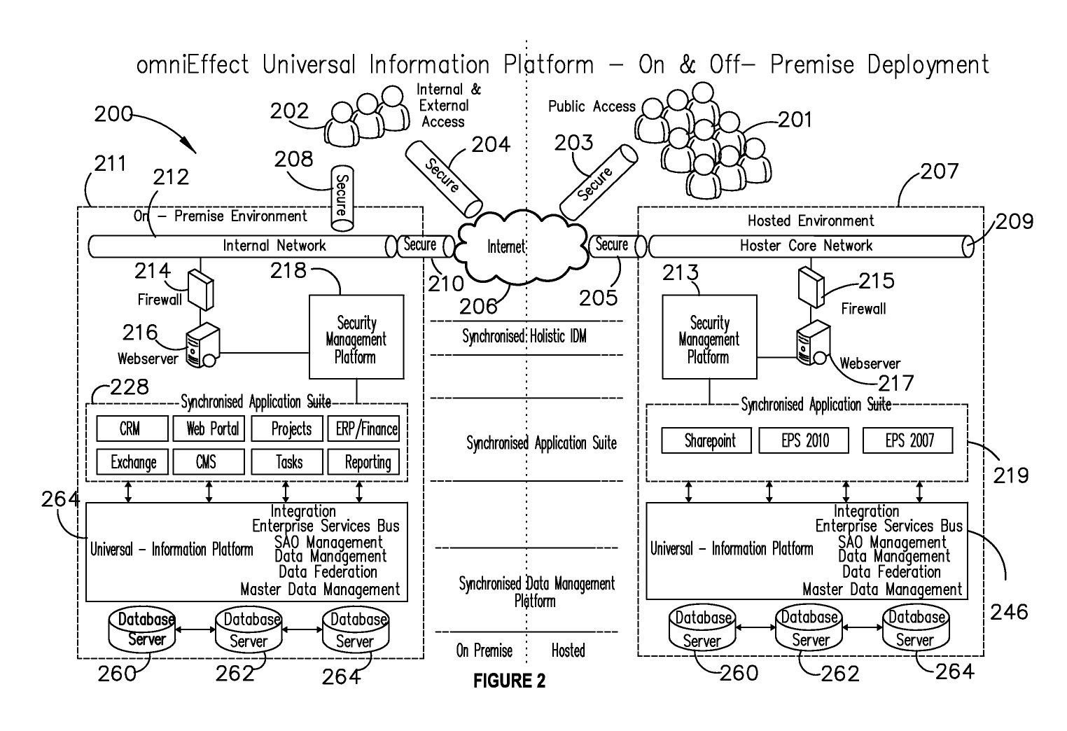

Referring to FIG. 2 there is a shown block diagram of a system 200 that depicts the logical positioning of a further embodiment of the invention within an organisation's information systems. This is where the organisation wishes to maintain a set of applications internally 211 and a set of applications or services externally in the Cloud 207. Thus a hosted environment 207 with a hoster's core network 209 remains in the Cloud and is accessible by a secure link 205 over the internet 206 either by the public 201 over a secure link 203 or from internal staff 202 over a secure link 204 connected to the internet 206. As before the internal staff 202 through link 208 can access the organisation's on-premise environment 211 and internal network 212. Here the firewall system 214, web server 216, security management platform 218, application suite 228, information platform 246 and data base service 260, 262 and 264 function in the same way as corresponding numbered features in FIG. 1. Internet services are fed with information controlled and managed from the organisation's networks; that is, from applications through the internal network 212 and from the hosting provider core network 209. The security management platform 213 also contains one or more IDM's as with security management platform 218. The information platform 246 underpins the system both internally and within the host provider. It is integrated not only to all core applications and content within the organisation but also within the hosting provider environment 207. Firewall system 215 acts in the same way as firewall system 214 and web server 217 likewise acts in a similar fashion to web server 216 and is connected between firewall 215 and the security management platform 213. Synchronized application suite 219 is linked both to the security management platform 213 and to the information platform 246. Information platform 246 contains the same platforms being integration, ESB, SOA management, data management, data federation and master data management, as with the information platform 146. The information platform processes information across both environments 211 and 207 synchronously and at scale, through business rules. Thus processing is at or near real time, however where there are data conflicts (such as updates or changes to data from more than one source), the business rules engine ensures that data is in alignment with organisational decisions and data modelling. Data is stored appropriately in multiple locations for redundancy, in data base servers 260, 262 and 264 in the external hosted environment 207 as well as in the on-premise environment 211.

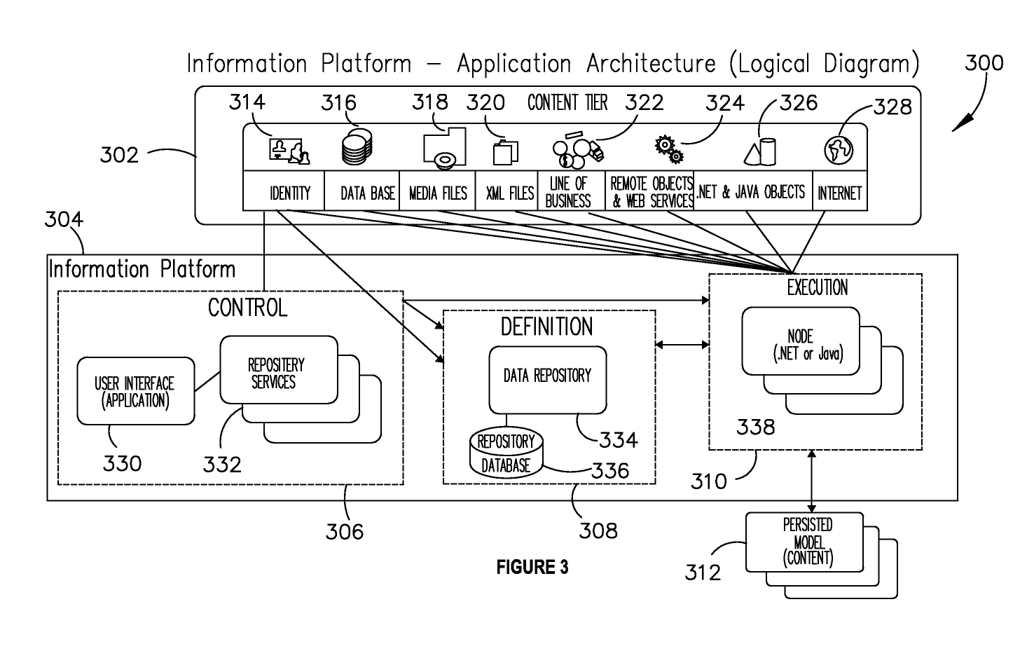

Referring to FIG. 3 there is shown a block diagram or logical diagram 300 depicting the information platform application architecture and more particularly the logical structure of the tiers of the n-tier application which comprises the information platform 304 and its interaction with the information content 302. The content tier 302 includes a number of different sources of content, information or data with which the information platform 304 interacts. Every information type is depicted together and includes: an identity information source 314, data base content 316, media files 318, ordinary files 320, line of business content 322, remote objects and web services content 324, dot net (.Net) and Java objects 326 and internet 328. Each information type is depicted together due to both the broad nature of the present system and the transformation capability which means any information type can be converted to any other information type. The content tier 302 contains all the data and information sources available to the information platform 304, and in particular identity information which is critical to the system's interactions.

The information platform 304 includes three separate tiers, being the control tier 306, the definition tier 308 and the execution tier 310 which interacts with persisted model (content) 312.

The control application layer or tier 304 includes a User Interface application 330 that enables a user to define and control the Repository Services 332. Both the User Interface application 330 and Repository Services 332 utilise any/all relevant sources of identity. This is so that every interaction undertaken has a context to the organisation, in that it is has appropriate permission levels, is appropriately tracked, and is appropriately secure. This can also have a bearing on the treatment of data interactions via business rules. The repository services 332 can be run across multiple instances to provide redundancy. Repository Services 332 enable the definition and control of all necessary information processes, and trigger their execution, hence its interaction with the Definition application layer or tier 308 and Execution application layer or tier 310.

The Definition layer 308 is linked to the Control application layer 306 and includes a Data Repository 334, which is the information definition applied to all processing of information through the Information Platform 304. It is the combination of organisational data models and business rulesets, combined with the super-metadata-model resulting from the interaction of every system and data source over time with the data model set itself. The Repository 334 tracks all changes to data and information over time and enables tagging of all information passing through the Information Platform 304. The Data Repository 334 has its own repository database 336 for storage. Data can also be stored in a non-database storage medium.

The Execution layer 310 is linked to each of the control layer 306 and the definition layer 308 and consists of Nodes 338 (which can also be termed ‘Agents’) that perform the processing of information for the platform 304. Multiple nodes 338 are indicated which is dependent on processing requirements. There can be unlimited nodes (dependent on infrastructure restrictions) that will add extra asynchronous processing power to any task or message queue. The nodes 338 can be run in dot Net (.Net) or Java code families. The nodes 338 are the execution agents, and consequently as they process data they update the Data Repository 334, and also create the Persisted Model 312 of data filtered through the system.

The data model definitions in the data repository 334 combine to treat data and information travelling through the platform 304 in order to ensure consistency in relation to the organisation's requirements and business rules. The treated data that is created from this is persisted into a model 312 that is stored (often as a database but can be another technology), which also contains the source of truth (SPOT—Single Point Of Truth) of every data item it contains.

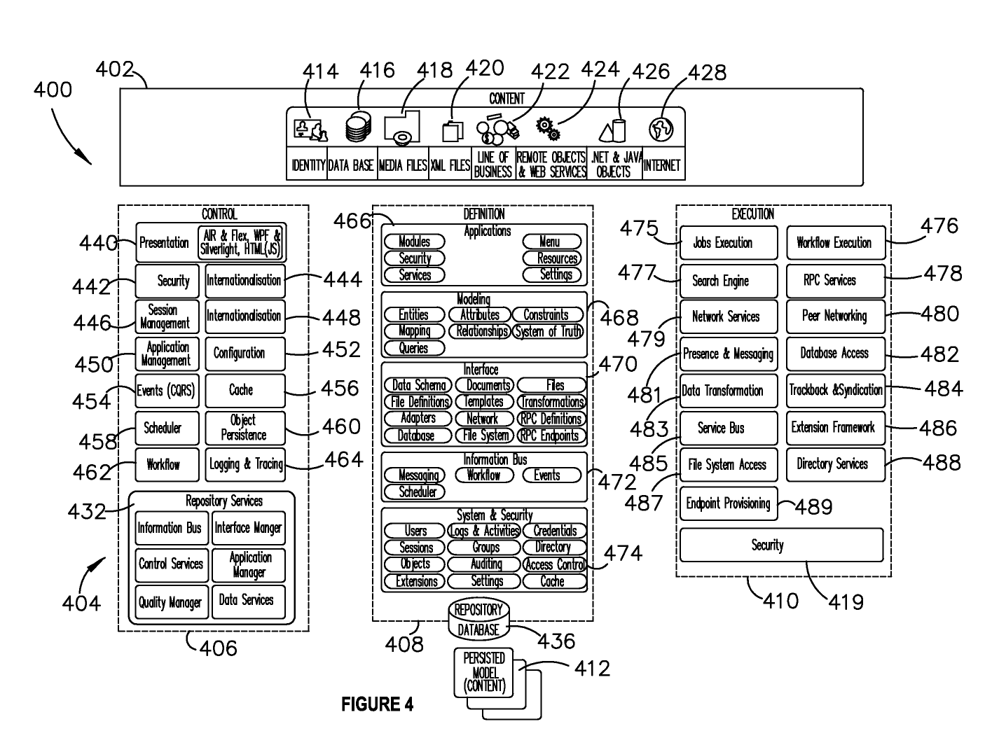

In FIG. 4 there is shown a more detailed block diagram 400 of each of the control application layer 406, the definition application layer 408 and the execution layer 410.

The control layer 406 includes modules 440 to 464 that are utilised within/by the user interface application 330 (FIG. 3). It includes a presentation module 440. Support for developing custom user interfaces with technologies such as Adobe AIR/Flex, Microsoft WPF & Silverlight and HTML 5 (JavaScript) are provided in the presentation module 440 including secure services and APIs for accessing Repository data from Repository Services 432. Interaction with the Data Repository 334 is via an application built on this architecture known as “Galaxo”. Furthermore bespoke applications targeted for Web, Desktop, Mobile and Devices can be developed given adherence to a “convention over configuration” design methodology used throughout the platform 404.

Security module 442 interacts with Repository 334 via secured services and controlled APIs. A user is required to be authenticated by the Repository 334 before being granted any access, and needs specific roles in order to manipulate and manage Repository Services objects.

Internationalisation module 444 provides application and system resources (i.e. messages) in multiple languages including support for localisation concepts such as date and currency formatting.

Session Management module 446 tracks user activity as part of core system security and the number of user sessions is monitored when connecting to the running instance.

Reporting module 448 provides for offline viewing of Repository data including statistics and auditing.

Application Management module 450 provides for definition and management of application functionality leveraging the Repository 334. Services functionality is modular and deployment and access can be monitored and controlled.

Configurations module 452 provides system settings and configuration of the Repository 334 though the Presentation layer.

Using the “Command Query Responsibility Segregation” (CQRS) pattern, events module 454 events can be published and subscribed to via the Presentation module/layer 440, Repository 334 and Node execution components 338.

Client and server-side caching of Repository object and throughput data can be monitored and managed through cache module 456.

Scheduler module 458 provides access to defining and executing Jobs across the platform 404.

Object Persistence module 460 provides Object Relational Mapping which is used to connect Presentation module/layer 440 and Nodes 338 with the Repository 334.

Workflow module 462 has the ability to sequence interactions between defined Repository objects with complete parameterisation.

Logging and tracing module 464 logs, audits and traces all activity within the platform 404, which is then made available via the presentation layer 440.

Repository Services 432 provides a complete set of secure services for interacting with the Repository 334. Broken by domain, these services provide control and definition of the platform's behaviour. Repository Services 432 includes the modules Information Bus, Interface Manager, Console Services, Application Manager, Quality Manager and Data Services.

The Definition Layer 408 includes five major components, the first of which is Applications Definition module 466 which holds implementation of an Application (available functionality to platform users) including Menu structures, Modules (Bundles), User Security, Services, Settings and Resources. These items are reused for application standardisation.

The second component is Data Modelling module 468 which holds the definition for modelling data moving through the Platform 404. It includes sub-modules of Entities, Attributes, Constraints, Mapping, Relationships, Systems of Truth and Queries. It is also used in validation, mapping and tagging activity.

The third component is Interface Definition module 470 which defines all connections and interaction behaviours to which the platform 404 requires access. It includes the sub-modules Data Schema, Documents, Files, File Definitions, Templates, Transformations, Adapters, Network, RPC Definitions, Database, File System and RPC Endpoints.

The fourth component is Information Bus module 472 which stores the design of the Information Bus and the required access to external service bus and messaging technologies. Furthermore the module 472 defines Workflows, Scheduling and Events.

The fifth component is System and Security module 474 which holds settings and User related topics such as Credential Providers and supports a local Directory for caching opportunities. It includes sub-modules for Users, Logging and Activity, Credentials, Sessions, Groups, Directory, Objects, Auditing, Access Control, Extensions, Settings and Cache.

The Execution Layer 410, which communicates with the Definition Layer 408 has a number of components. Job Execution module 475 enables each node defined within the platform 404 to execute a scheduled task or job. Jobs execute using a User Credential and defined or runtime parameters. Jobs are central to all operations.

Workflow Execution module 476, also known as Pipelines module, is a sequence of interconnected tasks each with custom parameters to carry out specific or long-running operations. Workflows allow End-Users to configure the system to perform highly specialised and complex integration activities.

Search Engine 477, built on Lucene, enables all data movements to be tagged in accordance with key search taxonomy. Nodes can also be configured to become search agents and target external sources such as web sites or services.

RPC (Remote Procedure Call) Services module 478 enables each node to have the ability to interact with open-standards-based procedure calls such as SOAP/XML, XML, JSON and Rest. The definitions for these interactions are contained within the Repository 334.

Network Services module 479 enables each node to have the ability to connect with common Networking protocols such as FTP, CIFS (SMB) and Windows shares.

Peer Networking module 480 enables each node to have the ability to use Networking presence and file sharing protocols.

Presence & Messaging module 481 enables publishing and subscribing to common messaging systems such as Microsoft MQ and Apache Active MQ. Furthermore, the system provides presence on XMPP protocols for the purpose of execution of defined Endpoints.

Database Access module 482 enables connection to common database vendors such as Microsoft SQL Server, Oracle Database, MySQL and Microsoft Access.

Data Transformation module 483 enables the transformation of data and referencing data in the Repository 334 using techniques exhibited in tools such as XSL and Apache Velocity.

As data is streamed through the platform, each node can extract and summarise data (information) to other outputs, creating simultaneous analysis on, and syndication of, original data items using the Trackback & Syndication module 484.

Service Bus 485 internally supports a messaging system for routing messages and execution of operations.

Extension Framework module 486 is a code development framework for the purpose of introducing custom features which may include system interactions and connectivity with systems.

File System Access module 487 enables each node with the ability to read/write to common file system types such as NTFS, MSDOS FAT, NFS and Google's HDFS (Hadoop).

Directory Services module 488 enables each node to have the ability to connect to common Identity/Directory systems such as LDAP, Active Directory, and custom systems developed as extensions to the Repository 334, for example Entrust and Crowd.

Endpoint Provisioning module 489 enables each node to have the ability to execute- and return results from Adapters, Workflows (Pipelines) and RPC Services, hence offering Web Service capability.

Security module 490 enables all operations to be carried out with a specific identity, which is core to a node's operation. Data transactions are filtered including support for certificates being used throughout each operation.

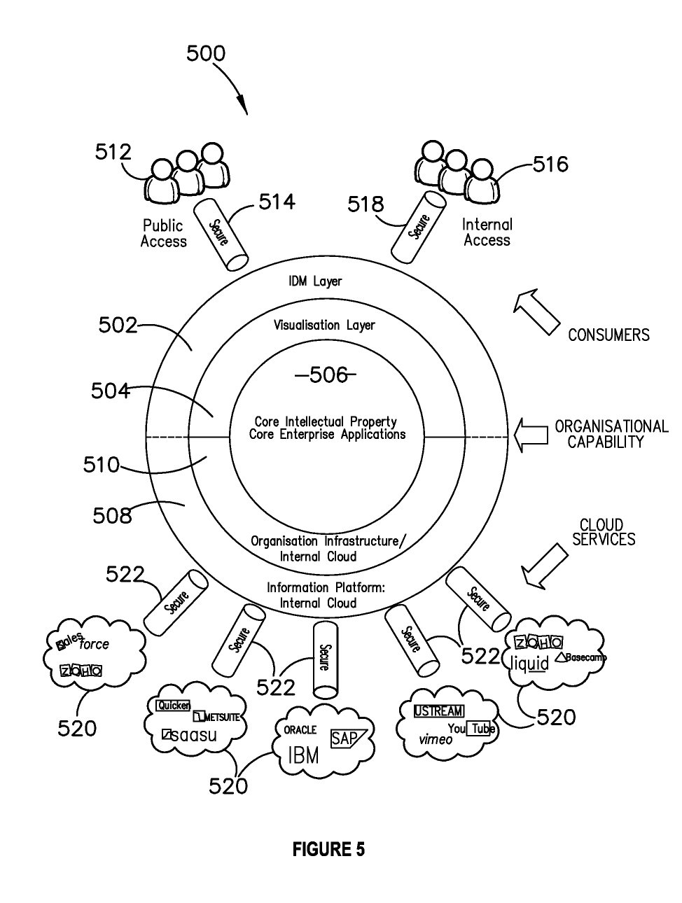

In FIG. 5 there is shown a block diagram 500 of a high-level information state of an organisation that has resolved data and application proliferation as well as combining on-premise and Cloud-based services. Access is provided into the system or services for the public and internal organisation staff. This is done through the IDM layer 502 and visualization layer 504. Cloud services 520 are able to access the information platform 508 and the organisation infrastructure 510 over secure links 522. The public 512 use a secure link 514 to interact with organisation services while internal staff 516 use secure link 518 to do the same. Permissions and available services or information may be different between the two groups as identity management is consistently applied across the organisation. The IDM layer 502 allows any level of authentication against those accessing organisational services. This multiple-factor capability minimises disruption and user-unfriendly processes. The context of the user, across the available services at RBAC (role based access control) level or IBAC (individual based access control) level, is controlled by the underpinning information platform 508.

Services are accessed through the consistent visualisation layer 504, which means that SSO (single sign on) is present to all applications. Development technologies and processes are consistent across the organisation. Therefore the user has a consistent experience no matter where they are within the organisation's environment.

Core information which is privy only to the organisation is held centrally in core, information systems and processes 506. These systems and processes remain within, and are controlled by, the organisation and reside on internal or private Cloud infrastructure. Due to the sensitivity of the core information it is not available on the public Cloud, although this can and may change over time. The information platform 508 underpins the integration of every application throughout the enterprise as well as to all external Cloud services. The IDM layer 502 and visualization layer 504 are enabled as the information platform 508 is in place to translate all data and system interactions, while maintaining data integrity across all data sources through the data models with business rules and with rapid processing at or near real time.

External Cloud services 520, accessed through secure links 522, are used for every item that is non-core to the organisation. These are easily integrated to the organisation's systems and data models through the information platform 508, which itself can reside in the Cloud.

In FIG. 6 there is shown a block diagram 600 depicting the integration and translation process of an embodiment of the invention. Two data sources 601 and 602 are used, but any number of data sources can be used. The data sources can be a system or structured/unstructured document or file.

Following the steps 1 to 15 in FIG. 6, at step 1 standard items are in place and configured that enable the Information Platform 604 to connect to a data source, have the required security to access the data source, define an interface method, and any data requirement is understood and modelled. Thus, the control tier/layer 606 accesses each of components 468, 470, 472 and 474 in the definition tier 608 to provide these requirements.

At step 2, a node is defined that will run in the execution tier 610. This node runs with its own security credential(s), which enables the platform 604 to operate under any security and access definitions within the organisation. That is, every node and every operation within the system can operate as a ‘who’, rather than just be a system (a ‘what’) with a single specific access definition.

At step 3, a workflow is defined in order to instruct the node with ‘what to do’. The workflow has an affinity to an execution node, and will be operated by that node as long as the node remains available. It will move to another node if the node is unavailable.

At step 4, the definitions of data sources are utilised to understand the Single Point Of Truth for any given piece of data.

At step 5, a data model is established which defines the requirements for the movement of the data between sources 601 and 602. This is in reference to/using the predefined data model for the data sources (step 1).

At step 6, class definitions and methods are instantiated as required and are inserted into the workflow.

At step 7, each workflow method uses a credential and composite of predefined communication elements (including the adapter) to enable connection to the required data source.

This is repeated as many times as required to achieve the required outcomes at step 8.

At step 9, the definition then occurs of the interaction/business rules for how the two systems will connect; what data needs to move; and any transformational processes that need to occur. (An example of a transformation might be: conversion of a value in a field into a value in another similar field, such as changing ‘AU’ (short for Australia) into ‘Australia’ in another system. This is known as a Key Domain Field conversion). This utilises the data model established in step 5, and any required data documents such as XSL-T.

At step 10, the now-defined node is instantiated in the execution tier 610.

At step 11, the defined workflow is executed by the node.

At step 12, the method for accessing data from data source 601 is executed.

At step 13, an ordered list is established of transformational actions to be carried out against data from data source 601, utilising the definition (step 9) and using the persisted model as a reference.

The method for accessing data source 602 is executed at step 14.

At step 15, based on the data model known to the transformation process, values are persisted in the persisted model 612 as per the result of the transformation process.

Each of steps 2, 3, 4, 6, 7 are initiated in a Generate Stage within the Definition Layer 608 while each of steps 10, 11 and 12 take place also in the Generate Stage in the execution layer 610. Step 7 is repeated as many times as required in the Aggregate Stage across both the definition layer 608 and execution layer 610. Steps 5 and 9 occur in a Transform Stage within the Definition Layer 608 while step 13 is carried out also in the Transform Stage but in the execution layer 610. Step 14 is executed in a Serialise Stage in the execution layer 610.

The data source translation takes place in the integration platform 604 using workflow control of data sources through the Generate, Aggregate, Transform and Serialise Stages to enable translation of any data source into any other type of data source.

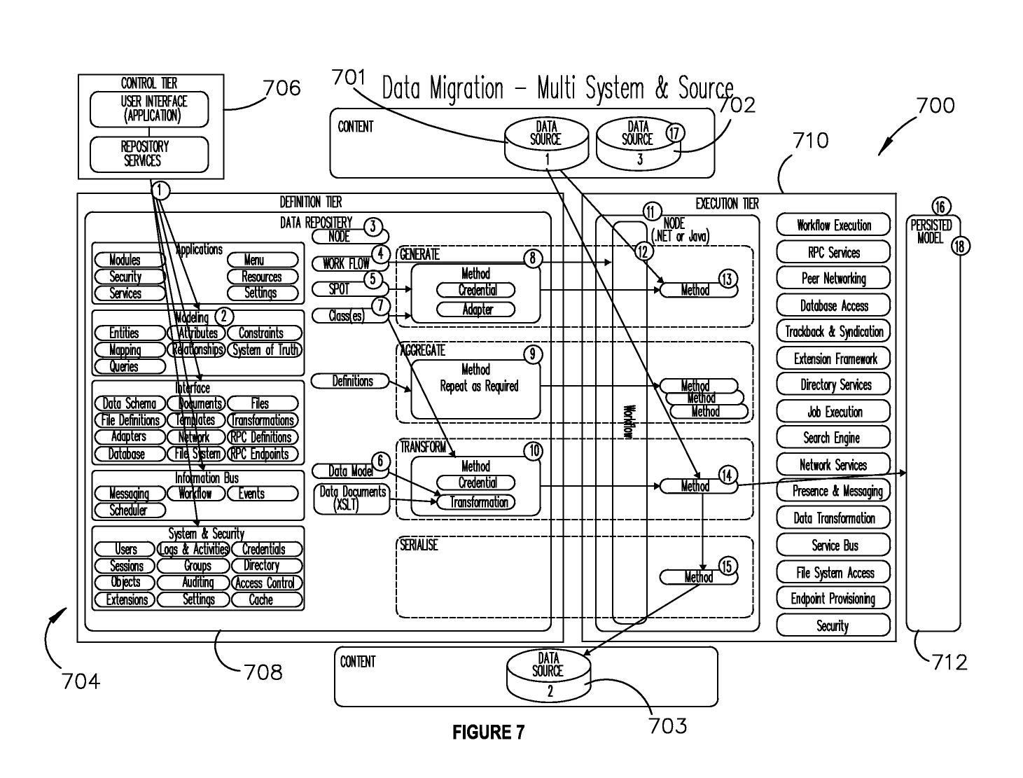

Referring to FIG. 7, there is shown a block diagram 700 depicting the integration and translation process of a further embodiment of the invention. There is shown the Information Platform and its ability to cover integration and data migration across multiple data sources 701, 702 and 703.

Following the steps 1 to 18 in FIG. 7, at step 1 standard items are in place and configured that enable the Information Platform 704 to connect to a data source, have the required security to access the data source, and to define an interface. Thus, the control tier/layer 706 accesses each of components 468, 470, 472 and 474 in the definition tier 708 to provide these requirements.

At step 2, data modelling is undertaken to understand the data components of systems to be integrated/migrated, and the overlaps between systems. Business rules as to data primacy (priority) and treatment of data items that will be processed are set; this combination of processing data from multiple systems, the ability to treat every data transaction with business rules, and a combinant (Master) data model, represents the core capability of Master Data Management.

At step 3, a node is defined that will run in the execution tier 710. This node runs with its own security credential(s), which enables the platform 704 to operate under any security and access definitions within the organisation. That is, every node and every operation within the system can operate as a ‘who’, rather than just be a system (a ‘what’) with a single specific access definition.

At step 4, a workflow is defined in order to instruct the node with ‘what to do’. The workflow has an affinity to an execution node, and will be operated by that node as long as the node remains available. It will move to another node if the node is unavailable.

At step 5, the definitions of data sources are utilised to understand the Single Point Of Truth (SPOT) for any given piece of data. Any given data change and its SPOT are stored with a key (GUID (Globally Unique Identifier) indexing). This represents Data DNA—complete historic tracking of all data alterations to data integrated with the Information Platform 704.

At step 6, a data model is established which defines the requirements for the movement of the data between sources 701 and 703. This is in reference to/using the predefined data model for the data sources (step 1).

At step 7, class definitions and methods are instantiated as required and are inserted into the workflow.

At step 8, each workflow method uses a credential and composite of predefined communication elements (including the adapter) to enable connection to the required data source.

This is repeated as many times as required to achieve the required outcomes at step 9.

At step 10, the definition then occurs of the interaction/business rules for how the two systems will connect; what data needs to move; and any transformational processes that need to occur. (An example of a transformation might be: conversion of a value in a field into a value in another similar field, such as changing ‘AU’ (short for Australia) into ‘Australia’ in another system. This is known as a Key Domain Field conversion). This utilises the data model established in step 5, and any required data documents such as XSL-T.

At step 11, the now-defined node is instantiated in the execution tier 710.

At step 12, the defined workflow is executed by the node.

At step 13, the method for accessing data from data source 701 is executed.

At step 14, an ordered list is established of transformational actions to be carried out against data from data source 701, utilising the definition (step 9) and using the persisted model as a reference.

The method for accessing data source 703 is executed at step 15.

At step 16, based on the data model known to the transformation process, values are persisted in the persisted model 712 as per the result of the transformation process.

At step 17, this process can then be repeated in either direction (i.e. 2-way integration) for any given system—such as data source 702 or any other. This process simultaneously embodies data-driven integration, data migration, and the ability to repeal (more accurately ‘undo’) data transactions.

At step 18, any further system that is to be integrated with, or data to be migrated to (a system that is integrated with the Information. Platform 704), can be referenced against the data model and the version of the data held within the Persisted Model 712. This means that data can not only be migrated or integrated; it can simultaneously be improved by being ‘sieved’ against data-in-place.

Each of steps, 3, 4, 5, 7 and 8 are initiated in a Generate Stage within the Definition Layer 708 while each of steps 11, 12 and 13 take place also in the Generate Stage in the execution layer 710. Step 9 is repeated as many times as required in the Aggregate Stage across both the definition layer 708 and execution layer 710. Steps 6 and 10 occur in a Transform Stage within the Definition Layer 708 while step 14 is carried out also in the Transform Stage but in the execution layer 710. Step 15 is executed in a Serialise Stage in the execution layer 710.

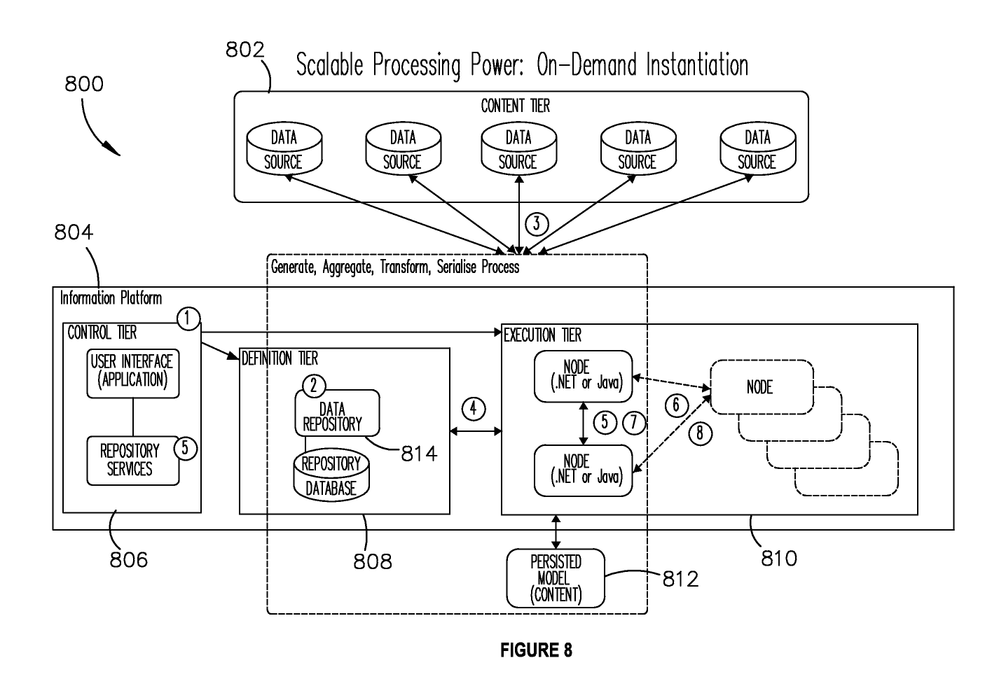

FIG. 8 is a block diagram 800 depicting a high-level architecture of the information platform 804.

Following steps 1 to 8 in FIG. 8, at step 1 business requirements are created and/or updated in the control tier/layer 806 that define the level of outstanding transactions, volume of nodes, the speed of transaction processing, or simply specific times, which are required to trigger extra node instantiation.

These requirements are stored as definitions within the system in data repository 814 at step 2.

At step 3, in the content tier 802, the various data sources are integrated, transformed and processed in the system as per the method disclosed in FIG. 7.

At step 4, using the data repository 814 as a central reference, nodes in the execution tier 810 can singularly reference or break down content to complete a task.

At step 5, all execution nodes communicate with each other for the purpose of balancing activity. Thus the system checks required parameters (transaction queues, node availability, transaction processing speeds, and job specifications) against the pre-defined business requirements.

At step 6, pre-configured non-active virtualised nodes are instantiated when required. Pre-configured inactive nodes are deployed on virtualised machines that are then available immediately when commanded.

At step 7, the system continues to monitor required parameters.

At step 8, any extra non-required nodes are returned to dormancy when any threshold criteria are reached.

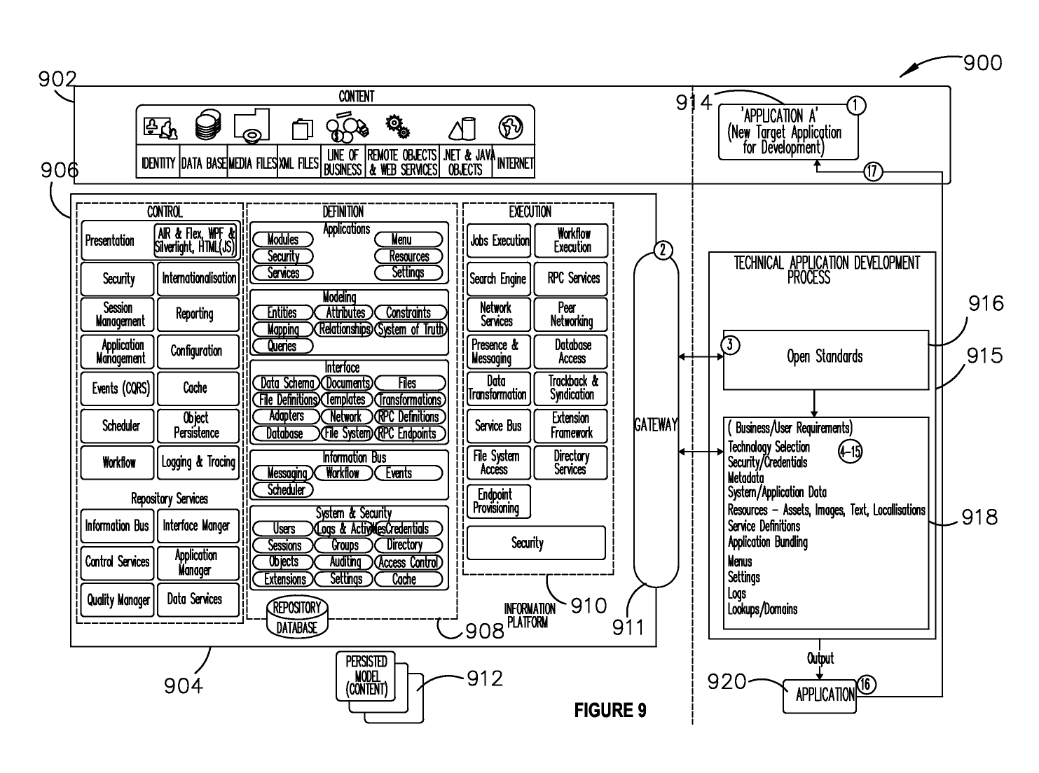

Referring to FIG. 9, there is shown a block diagram 900 depicting a detailed application architecture of the information platform 904 similar to that shown in FIG. 4, together with an application development process. It uses Application Standardisation and Acceleration Platform (ASAP), which is part of the platform 904.

Following steps 1 to 17 in FIG. 9, at step 1 the organisation/users in question wish to build/develop an application 914.

At step 2, The Information Platform 904 incorporates an information gateway 911 for communication with all data sources and systems.

At step 3, the Platform 904 is technology agnostic, and provides access to data and information via any/all standards 916 provided by WWWC. That is, the information is available and accessible rather than restricted or proprietary.

At step 4, the start of the development process 918, business and user requirements (whether formalised or not) exist, as per step 1; and these are the trigger for the creation of the application 914. Requirements can consist of almost any concept, to any level of detail, from ‘I would like a nice tool that shows me on a map where our offices are located’ through to large, complex organisations wanting to build complex applications—for example a full payroll or investment management system.

Technology Selection at step 5 can vary based on “Reach” and “User Experience” for delivering Application functionality. There is no restriction to this imposed by the Information Platform 904. The Information Platform 904 enables/facilitates use of Model Driven Architectures. This enables a generative outcome across multiple software frameworks/platforms (manual development is also possible).

At step 6, Security/Credentials are considered and the Platform 904 provides surrogate Identity Management returning a unique User Credential.

At step 7 for Metadata, the Platform 904 defines/classifies (classes) of data structures. These can then be reused throughout any Application(s).

At step 8 (system/application data) the Platform 904 stores domain(s) of data values that can be reused throughout Application(s), for example a list of countries.

At step 9, (Resources such as assets, images, text, localisations) the Platform 904 stores or locates resources used by or generated into resulting Application(s). For example, translated textual messages or imagery.

At step 10, the Platform 904 defines all data services with which applications can interact, for example, ‘Get Employee List’.

At step 11 (Application Bundling) the platform 904 is modularised through definition, providing a scalable infrastructure for delivering specific Application features/functions to Users. Any module can be reused/recreated into another application extremely rapidly.

At step 12 (menus), the Platform 904 stores and manages User Menus for applications based on user credentials. That is, when providing a user credential, the Platform will offer a menu for the module and application combination which is contextualised for that user.

At step 13 (Settings), the Platform 904 retains Global or Environment-Specific settings for any application to utilise.

At step 14 (Logs) the Platform 904 provides a centralised logging mechanism.

At step 15 (Lookups/Domains), the Platform 904 provides consistent definition of ‘Domain of Values’ used throughout Application Look-Ups. This is both consistent from any data source (not just one system) and also contextualised to the user.

At step 16, the output from the development process 918 is an application 920 that has been developed in accordance with the technology selection(s) of the organisation/users, and has been developed both faster (than otherwise possible) and in a consistent manner with the defined standards and data requirements of the organisation/users.

At step 17, the application 920/914 is then available as content, or a data source, to the Information Platform 904 for ongoing interaction.

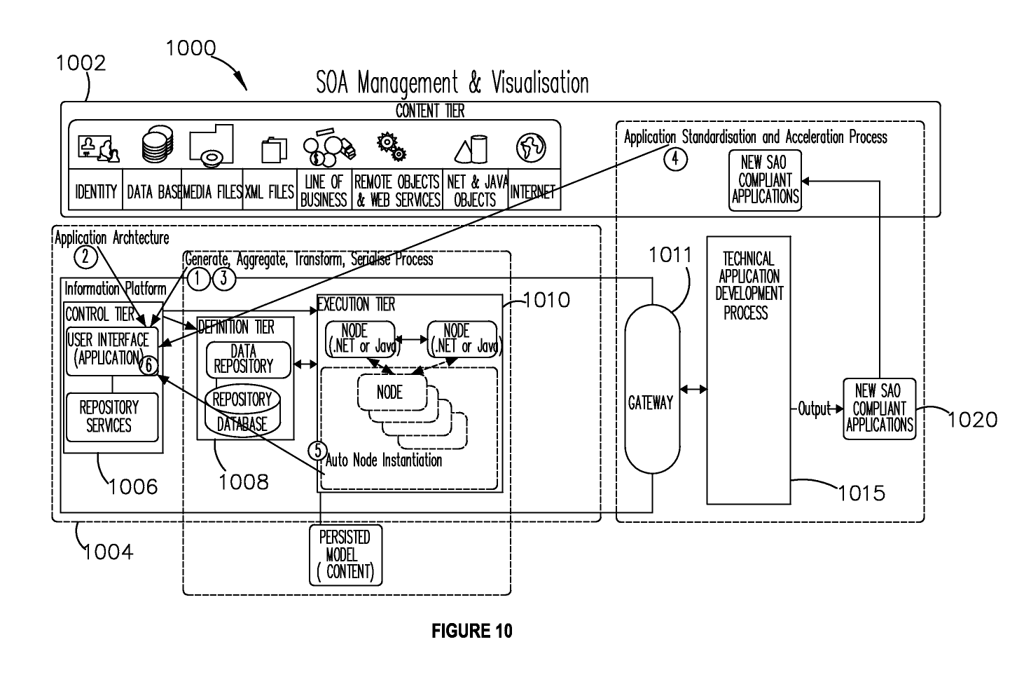

Shown in FIG. 10 is a block diagram 1000 of the architecture of information platform 1004 at a high level. It depicts the application architecture, integration capability, processing capability, and the application development process, and then depicts how these relate to the ability to manage and visualise Service Oriented Architecture.

At step 1, the Information. Platform 1004 manages and controls the integration process for all required data sources, as described elsewhere and illustrated in FIG. 6. This information is consequently available for management and visualisation within the user interface.

At step 2, the Information Platform 1004 contains its own Enterprise Services Bus, and also communicates through messaging standards and the Integration Platform 1004 with any other ESB utilised by an organisation. This information is consequently available for management and visualisation within the user interface.

At step 3, data source translation is managed and controlled by the Information Platform 1004 as described elsewhere and illustrated in FIG. 6. This information is consequently available for management and visualisation within the user interface.

At step 4, the ASAP (Application Standardisation and Acceleration Platform) is part of the Information Platform 1004, enabling consistent and simplified application development; this is depicted elsewhere in FIG. 9. All application development work undertaken and data used in the ASAP is consequently available for management and visualisation within the user interface.

At step 5, the Information Platform 1004 has an execution tier 1010 that utilises processing nodes. These processing nodes can operate independently and also communicate with each other and all other application tiers. They are distributed/distributable and can be instantiated on demand as per FIG. 8. All this information is consequently available for management and visualisation within the user interface.

At step 6, the combination of capabilities within the Information Platform 1004 means it is possible to visualise and manage an extensive amount of information that is critical for effective SOA. All this information is available in standard formats, such as data tables (for example listings of the available data sources and Services). The organisation's Information Landscape can be visualised graphically, including all data sources, ESBs. Messaging tools, and any other system. A specific example is that the Information Platform 1004 contains an Information Landscape visualisation known as the ‘Galaxy’ that contains the organisation's own structure, every system and data source, every integration, and every data workflow, in a single navigable map.

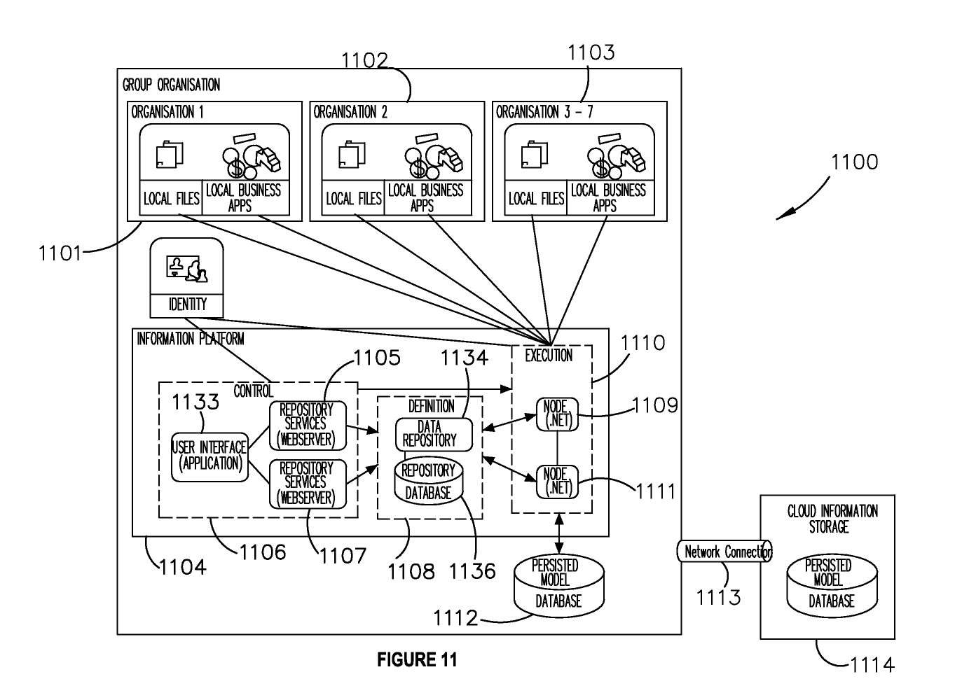

FIG. 11 shows an embodiment of the invention in which organisation number one (1101) wishes to store information in the Cloud. The organisation 1101 has the following characteristics and goals:

### Characteristics:

At least 100 internal software applications.

At least 500 flat files and spreadsheets.

Multiple organisations within one group.

Multiple physical locations, including international.

### Goals:

Migrate core software applications onto one platform including new software.

Keep old systems running on an ongoing basis (until the business decides to cease usage on a per-application basis).

Ensure all software systems communicate in real-time.

Not to disturb the tools currently in use, minimising disruption—both systems and files.

Incorporate at least 500 flat files and spreadsheets into the integrated system, minimising disruption.

Host the system both on premise and in the cloud for data redundancy.

Give access to the data to multiple countries.

Improve reporting across the whole information system—both applications and files.

Referring to FIG. 11, there is depicted a block diagram 1100 with the Information Platform 1104 as deployed to the organisation's requirements.

The information platform 1104, control tier 1106, definition tier 1108 and execution tier 1110 are all deployed on-premise. Two Repository Services (Webservers) 1105 and 1107 are in place to ensure redundancy of operation for users. The execution tier 1110 has two processing nodes 1109, 1111 to ensure ample processing power, as well as redundancy of processing capability.

The group organisation contains seven different organisational entities 1101, 1102 and 1103, each with its own files and systems that require integration. The integration capability operates through the execution tier 1110, integrating all of the 500+ flat files and more than 100 software applications.

Identity is managed consistently across the group of organisations meaning that only a single Identity/IDM integration is required for all organisations. All organisations are held within a single domain and network architecture, meaning further network connections and identity solutions are not required.

In order to ensure redundancy of data, a network connection 1113 exists utilising a private VPN out to a hosting services provider, giving Cloud Information Storage 1114.

this Enables Completion of Goals as Follows:
Migrate core software applications onto one platform including new software—this is a standard function of integration to the Information Platform 1104.
Keep old systems running on an ongoing basis (until the business decides to cease usage on a per-application basis) This is a function of integration to the Information Platform 1104.
Ensure all software systems communicate in real-time. This is a function of integration to the Information Platform 1104.
Not to disturb the tools currently in use, minimising disruption to both systems and files. This is a function of integration to the Information Platform 1104.
Incorporate at least 500 flat files and spreadsheets into the integrated system, minimising disruption. This is a function of integration to the Information Platform 1104 and is shown as the integrations to multiple organisational entities in FIG. 11.
Host the system both on premise and in the cloud for data redundancy. This is demonstrated via the Cloud Information Storage 1114 (the requirement in this case is for Data Redundancy, rather than specifically hosting the application itself).
Give access to the data to multiple countries. This is achieved through the hosting provider holding the persisted resultant data model from the organisation, which is then available for analysis. This can also be accessed through the execution layer 1110 directly.
Improve reporting across the whole information system, both applications and files. Data is improved across the organisation by the data models and real time integrations. This reporting improvement is specifically achieved, in this instance, by accessing of the persistent resultant data model.

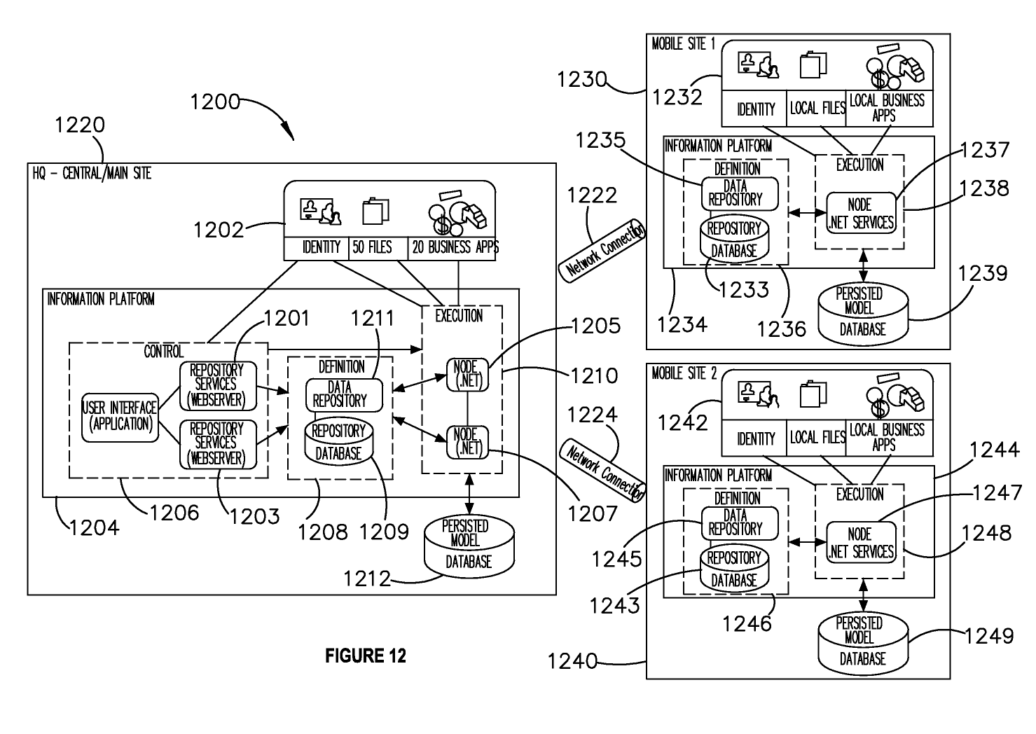

Referring to FIG. 12, there is depicted a block diagram 1200 with the Information Platform 1204 as deployed to the organisation's requirements. Example organisation number 2 is an organisation that has the following characteristics and goals:

### Characteristics:

At least 20 Internal software applications.

Approximately 50 flat files and spreadsheets.

One single organisation.

Multiple project-based mobile locations with poor physical links/network connections.

### Goals:

Integrate a standard set of 20 software applications into one platform.

Integrate a set of approximately 50 flat files and spreadsheets into the integrated system, minimising disruption.

Create data redundancy across multiple site locations (implement local data stores in order to maintain operations when network links are down).

Ensure data communication is as consistent as possible across multiple inconsistent connections.

Manage data inconsistencies from dropped links, and therefore the multiple separate data updates.

Prioritise important data over other data due to weak network bandwidth.

Have a small footprint for the information platform, enabling software to be placed onto two mobile servers for new locations at short notice.

Referring to FIG. 12, the primary deployment exists within the organisation HQ or central site 1220, with the control tier 1206 having two Repository Services (webservers) 1201, 1203 for redundancy of operation. The execution tier 1210 has two processing nodes 1205, 1207 to ensure processing sufficiency and redundancy. The Data Repository 1211 and Repository Database 1209 are in definition tier 1208, with the resultant persistent model of data existing on a database 1212. The predominance of applications to be integrated is within the HQ site 1220, and these are integrated via the execution tier 1210. Identity is utilised by the Control and Execution tiers 1206, 1210.

The organisation has network connections out to mobile sites 1230 and 1240, and the platform configuration for each mobile site is the same. This is designed as such due to the requirements for local integration and data redundancy, and is not influenced by the number of local applications or files.

Each mobile site 1230, 1240 has a set of local business applications and files, and a local instance of IDM (Identity management). To ensure data redundancy, the persisted model is held in a local database 1239, 1249, so that in the event of a network connection outage the platform 1234, 1244 can operate locally as if all other applications are still accessible (with the information state as at the time of the network connection outage). Each mobile site 1230, 1240 has a single processing node 1237, 1247 as the data volumes are relatively low in the local site environment. The mobile site deployment is the same for each site 1230, 1240, so the diagram/model simply extends to the number of sites required at any given time.

this Enables Completion of Goals as Follows:
Integrate a standard set of 20 software applications into one platform. This is a function of integration to the Information Platform 1204, 1234, 1244 and is shown as the integrations to multiple application sets at different sites in FIG. 12.
Integrate a set of approximately 50 flat files and spreadsheets into the integrated system, minimising disruption. This is a function of integration to the Information Platform 1204, 1234, 1244 and is shown as the integrations to multiple file sets at different sites in FIG. 12.
Create data redundancy across multiple site locations (local data stores in order to maintain operations when network links are down). This is achieved by the local Data Repository 1235, 1245, Repository Database 1233, 1243, and Persisted. Model database 1239, 1249.
Ensure data communication is as consistent as possible across multiple inconsistent connections. This is achieved by deploying the information platform processing nodes 1237, 1247 into each mobile site (along with data redundancy, above). The combination allows data to continue to be updated across the application set, and when the network connection reconnects, only data updates need to be sent through rather than all transactions.
Manage data inconsistencies from dropped links, and therefore the multiple separate data updates. This is achieved by deploying the information platform processing nodes 1237, 1247 into each mobile site (along with data redundancy, above). The combination allows data to continue to be updated across the application set, and when the network connection reconnects, only data updates need to be sent through rather than all transactions.
Prioritise important data over other data due to weak network bandwidth. This is a feature of the Information Platform processing nodes and data workflows.
Have a small footprint for the information platform, enabling software to be placed onto two mobile servers for new locations at short notice. This is achieved by the architectural design of the Information Platform. The Systems Integration, SOA Management and ESB, Data Federation, Data Management and Storage, and Master Data Management, are all deployed onto a single (hardware) server for use on site.

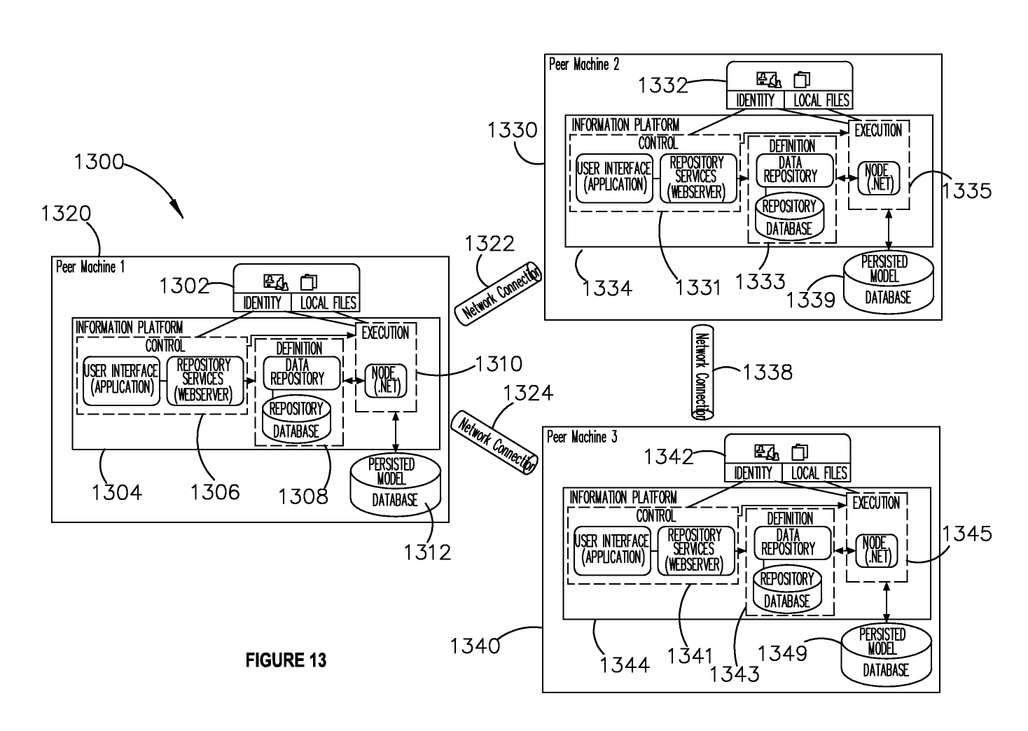

Referring to FIG. 13 there is shown a block diagram 1300 of the information platform 1304 deployed to a group's requirements. Example organisation number three is an organisation (more specifically, a group of people that is not an organisation) that has the following characteristics and goals:

### Characteristics:

About 50 flat files and spreadsheets.

Peer group of stand-alone machines.

No central store of data or coordinated information share.

Individuals are geographically distributed.

### Goals:

Share a set of approximately 50 flat files and spreadsheets across the peer group.

Ensure data communication is as consistent as possible across multiple inconsistent connections.

Ensure data communication is secure between/amongst the group.

Have a small footprint for the information platform, enabling software to be placed onto each stand-alone machine.

Enable on-the-fly combination and analysis of the data from the different data sources on an individual or group basis.

Enable conversion of documents and files, and combinations of resultant data from analysis, into any format required by each individual.

Provide data and document updates in real-time.

(Enable SaaS processing power and data storage across the set of files and documents).

Referring to FIG. 13, each individual within the group has deployed the information platform 1304, 1334 and 1344, containing the Control, Definition and Execution tiers. Only single instances of the Repository Services and Execution nodes are required due to the light processing requirements. Each individual has also deployed a Persistent Model database 1312, 1339, 1349 to their machine.

Each instance of the Information Platform is configured to talk to the other instances within the group, which is possible via the defined network connections.

This enables completion of goals as follows:
Share a set of approximately 50 flat files and spreadsheets across the peer group. This is a function of integration to the Information Platform.
Ensure data communication is as consistent as possible across multiple inconsistent connections. This is achieved by deploying an information platform processing node into each site/machine, along with data redundancy from the local data repository and persisted model; the combination allows data to continue to be updated across the application set, and when the network connection reconnects, only data updates need to be sent through rather than all transactions.
Ensure data communication is secure between/amongst the group. This is a function of the Information Platform. This is achieved by support for identity management, as well as certification of communication and transactions and encryption of data.
Have a small footprint for the information platform, enabling software to be placed onto each stand-alone machine. This is achieved by the architectural design of the Information Platform. The Systems Integration, SOA Management and ESB, Data Federation, Data Management and Storage, and Master Data Management, are all deployed onto a single machine.
Enable on-the-fly combination and analysis of the data from the different data sources on an individual or group basis. This is a function of integration to the Information Platform. This facility is provided for the user by the control interface.
Enable conversion of documents and files, and combinations of resultant data from analysis, into any format required by each individual. This is a function of integration to the Information Platform.
Provide data and document updates in real-time. This is a function of integration to the Information Platform.
Enable SaaS processing power and data storage across the set of files and documents to (not shown). This is provided by accessing the SaaS deployment of the Information Platform. All data and information requested or required will be stored in the Cloud, and the scalable processing power of the Cloud ensures that processing will not be delayed.

1. A data management method enabling translation of content of a first data source into a second data source using an information platform having a control layer, a definition layer and an execution layer, the method including:
connecting the information platform to the first data source by defining a workflow method in the definition layer to connect to the first data source;
establishing a data model in the definition layer to define requirements for the movement of data between the first data source and the second data source;
defining rules how the first and second data sources connect to one another including required transformations;
instantiating at least one node in the execution layer under the instruction of the workflow method;
executing the workflow method by at least one node to access data from the first data source;
establishing transformations to be carried out against the second data source using the defined rules;
executing the workflow method by at least one node to access data from the second data source; and
persisting data values in a persisted model based on the transformations.

2. A method according to claim 1 further enabling translation of content between multiple data sources by repeating the steps of claim 1 for each additional data source.

3. A method according to claim 1 or claim 2 further including using multiple nodes executed in the execution layer to cater for increased processing loads.

4. A computer-readable medium including computer-executable instructions that, when executed on a processor, in a data management method enabling translation of content of a first data source into a second data source using an information platform, said platform having a control layer, a definition layer and an execution layer, directs the processor to undertake the steps of any one of the preceding claims.

5. A data management system enabling translation of content of a first data source into a second data source, the system including:
server means accessed through a communications network;
an information platform located on said server;
data storage means linked to said information platform;
wherein said information platform includes a control layer, a definition layer and an execution layer, each layer interacting with the other two layers;
wherein further the translation of the content between the data sources uses a workflow method executed in the execution layer and uses a data model to define requirements for the movement of data between the first data source and the second data source.

6. A system according to claim 5 where in order to develop an application ASAP (Application Standardisation and Acceleration Platform) is used together with one or more open standards, the application and specific data sources being linked to the information platform through a gateway.

7. A system according to claim 5 or claim 6 wherein the application enables SOA compliance by facilitating tracking of all data, transactions, sources, messaging and systems integrated to the system.

8. A system according to claim 5 wherein the information platform includes an ESB to enable distributed messaging between separate applications or data sources.

9. A system according to claim 5 wherein a portion or portions of the information platform is or are stored on multiple internal or externally hosted networks.

10. A system according to claim 6 wherein the information platform includes an ESB to enable distributed messaging between separate applications or data sources.

11. A system according to claim 6 wherein a portion or portions of the information platform is or are stored on multiple internal or externally hosted networks.

12. A system according to claim 5 wherein the application enables SOA compliance by facilitating tracking of all data, transactions, sources, messaging and systems integrated to the system and wherein the information platform includes an ESB to enable distributed messaging between separate applications or data sources.

13. A system according to claim 10 wherein the application enables SOA compliance by facilitating tracking of all data, transactions, sources, messaging and systems integrated to the system.

14. A system according to claim 9 wherein the application enables SOA compliance by facilitating tracking of all data, transactions, sources, messaging and systems integrated to the system.

15. A system according to claim 11 wherein the application enables SOA compliance by facilitating tracking of all data, transactions, sources, messaging and systems integrated to the system.

16. A system according to claim 9 wherein the information platform includes an ESB to enable distributed messaging between separate applications or data sources.
